(19) United States
(12) Patent Application Publication
(10) Pub. No.: US 2015/0081723 A1
(43) Pub. Date: Mar. 19, 2015

(54) System and Method for Analyzing and Synthesizing Social Communication Data

(71) Applicant: Marketwire L.P., Toronto (CA)

(72) Inventor: Stuart OGAWA, Los Gatos, CA (US)

(21) Appl. No.: 14/487,782

(22) Filed: Sep. 16, 2014

Related U.S. Application Data
(60) Provisional application No. 61/880,027, filed on Sep. 19, 2013.

(51) Int. Cl. H04L 12/18; G06F 17/30

(52) U.S. Cl. CPC H04L 12/1813; G06F 17/30876; G06F 17/30595
USPC 707/748; 707/736; 709/204

(57) ABSTRACT

A system and method are provided for analysing and communicating social data. A method performed by a computing device or server system includes obtaining the social data from one or more sources. The method includes composing a new social data object derived from the social data and transmitting the new social data object. The method also includes obtaining at least one feedback associated with the new social data object that is transmitted and computing an adjustment command using said feedback. Accordingly, executing the adjustment command adjusts at least one of steps of obtaining, composing, and transmitting for subsequent social data objects in dependence upon said feedback.

### CROSS-REFERENCE TO RELATED APPLICATIONS:

This application claims priority to U.S. Provisional Patent Application No. 61/880,027 filed on Sep. 19, 2013, and titled “System and Method for Continuous Social Communication”, the entire contents of which is incorporated herein by reference.

### TECHNICAL FIELD

The following generally relates to communication of social data and particularly, synthesizing social communication data based upon feedback of said communication.

### BACKGROUND

In recent years social media has become a popular way for individuals and consumers to interact online (e.g. on the Internet). Social media also affects the way businesses aim to interact with their customers, fans, and potential customers online.

Typically a person or persons create social media by writing messages (e.g. articles, online posts, blogs, comments, etc.), creating a video, or creating an audio track. This process can be difficult and time consuming.

### BRIEF DESCRIPTION OF THE DRAWINGS

Embodiments will now be described by way of example only with reference to the appended drawings wherein:

FIG. 1 is a block diagram of a social communication system interacting with the Internet or a cloud computing environment, or both.

FIG. 2 is a block diagram of an example embodiment of a computing system for social communication, including example components of the computing system.

FIG. 3 is a block diagram of an example embodiment of multiple computing devices interacting with each other over a network to form the social communication system.

FIG. 4 is a schematic diagram showing the interaction and flow of data between an active receiver module, an active composer module, an active transmitter module and a social analytic synthesizer module.

FIG. 5 is a flow diagram of an example embodiment of computer executable or processor implemented instructions for composing new social data and transmitting the same.

FIG. 6 is a block diagram of an active receiver module showing example components thereof.

FIG. 7 is a flow diagram of an example embodiment of computer executable or processor implemented instructions for receiving social data.

FIG. 8 is a block diagram of an active composer module showing example components thereof.

FIG. 9A is a flow diagram of an example embodiment of computer executable or processor implemented instructions for composing new social data.

FIG. 9B is a flow diagram of an example embodiment of computer executable or processor implemented instructions for combining social data according to an operation described in FIG. 9A.

FIG. 9C is a flow diagram of an example embodiment of computer executable or processor implemented instructions for extracting social data according to an operation described in FIG. 9A.

FIG. 9D is a flow diagram of an example embodiment of computer executable or processor implemented instructions for creating social data according to an operation described in FIG. 9A.

FIG. 10 is a block diagram of an active transmitter module showing example components thereof.

FIG. 11 is a flow diagram of an example embodiment of computer executable or processor implemented instructions for transmitting the new social data.

FIG. 12 is a block diagram of a social analytic synthesizer module showing example components thereof.

FIG. 13 is a flow diagram of an example embodiment of computer executable or processor implemented instructions for determining adjustments to be made for any of the processes implemented by the active receiver module, the active composer module, and the active transmitter module.

FIG. 13A is a flow diagram of another example embodiment of computer executable or processor implemented instructions for determining adjustments implemented by the synthesizer module for any of the processes implemented by the active receiver module, the active composer module, and the active transmitter module.

FIG. 13B is a flow diagram of an example embodiment of computer executable or processor implemented instructions for determining adjustments for any of the processes implemented by the active receiver module, the active composer module, and the active transmitter module based upon feedback received.

FIG. 14 is a flow diagram showing an example for determining an inflection point.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Social data herein refers to content able to be viewed or heard, or both, by people over a data communication network, such as the Internet. Social data includes, for example, text, video, graphics, and audio data, or combinations thereof. Examples of text include blogs, emails, messages, posts, articles, comments, etc. For example, text can appear on websites such as Facebook, Twitter, LinkedIn, Pinterest, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for businesses to effectively listen to and communicate with their customers. The increasing number of websites, channels, and communication modes can overwhelm businesses with too much real time data and little appropriate and relevant information. It is also recognized that people in decision making roles in business are often left wondering who is saying what, what communication channels are being used, and which people are important to listen to.

It is recognized that typically a person or persons generate social data. For example, a person generates social data by writing a message, an article, a comment, etc., or by generating other social data (e.g. pictures, video, and audio data). This generation process, although sometimes partially aided by a computer, is time consuming and uses effort by the person or persons. For example, a person typically types in a text message, and inputs a number of computing commands to attach a graphic or a video, or both. After a person creates the social data, the person will need to distribute the social data to a website, a social network, or another communication channel. This is also a time consuming process that requires input from a person.

It is also recognized that when a person generates social data, before the social data is distributed, the person does not have a way to estimate how well the social data will be received by other people. After the social data has been distributed, a person may also not have a way to evaluate how well the content has been received by other people. Furthermore, many software and computing technologies require a person to view a website or view a report to interpret feedback from other people.

It is also recognized that generating social data that is interesting to people, and identifying which people would find the social data interesting is a difficult process for a person, and much more so for a computing device. Computing technologies typically require input from a person to identify topics of interest, as well as identify people who may be interested in a topic. It also recognized that generating large amounts of social data covering many different topics is a difficult and time-consuming process. Furthermore, it is difficult achieve such a task on a large data scale within a short time frame.

The proposed systems and methods described herein address one or more of these above issues. The proposed systems and methods use one or more computing devices to receive social data, identify relationships between the social data, compose new social data based on the identified relationships and the received social data, and transmit the new social data. In a preferred example embodiment, these systems and methods are automated and require no input from a person for continuous operation. In another example embodiment, some input from a person is used to customize operation of these systems and methods.

The proposed systems and methods are able to obtain feedback during this process to improve computations related to any of the operations described above. For example, feedback is obtained about the newly composed social data, and this feedback can be used to adjust parameters related to where and when the newly composed social data is transmitted. This feedback is also used to adjust parameters used in composing new social data and to adjust parameters used in identifying relationships. Further details and example embodiments regarding the proposed systems and methods are described below.

The proposed systems and methods may be used for real time listening, analysis, content composition, and targeted broadcasting. The systems, for example, capture global data streams of data in real time. The stream data is analyzed and used to intelligently determine content composition and intelligently determine who, what, when, and how the composed messages are to be sent.

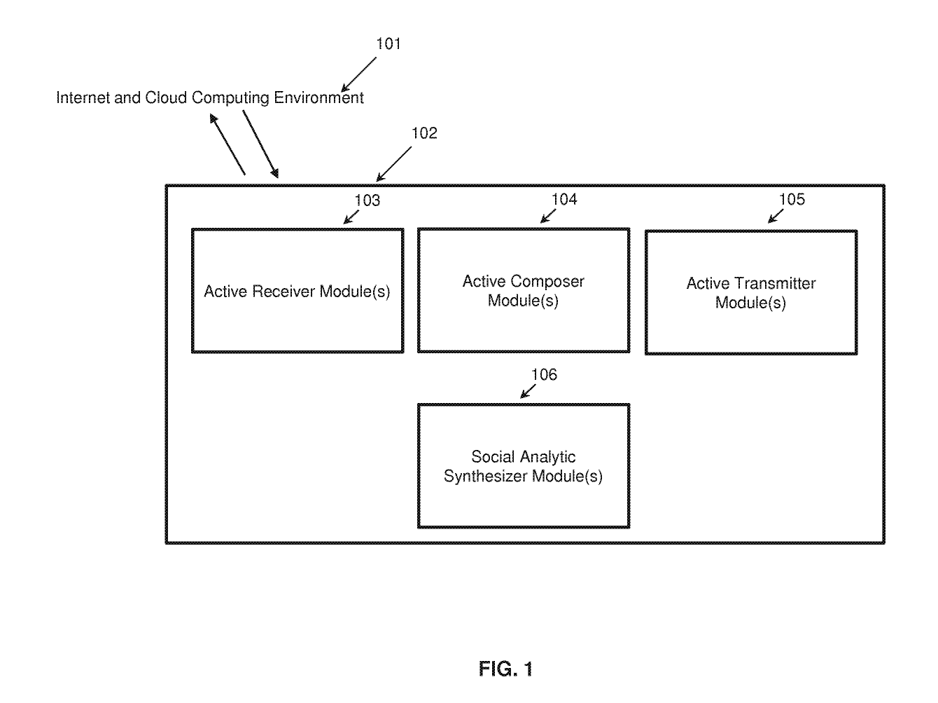

Turning to FIG. 1, the proposed system 102 includes an active receiver module 103, an active composer module 104, an active transmitter module 105, and a social analytic synthesizer module 106. The system 102 is in communication with the Internet or a cloud computing environment, or both 101. The cloud computing environment may be public or may be private. In an example embodiment, these modules function together to receive social data, identify relationships between the social data, compose new social data based on the identified relationships and the received social data, and transmit the new social data.

The active receiver module 103 receives social data from the Internet or the cloud computing environment, or both. The receiver module 103 is able to simultaneously receive social data from many data streams. The receiver module 103 also analyses the received social data to identify relationships amongst the social data. Units of ideas, people, location, groups, companies, words, number, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The active composer module 104 uses the relationships and social data to compose new social data. For example, the composer module 104 modifies, extracts, combines, or synthesizes social data, or combinations of these techniques, to compose new social data. The active composer module 104 outputs the newly composed social data. Composed social data refers to social data composed by the system 102.

The active transmitter module 105 determines appropriate communication channels and social networks over which to send the newly composed social data. The active transmitter module 105 is also configured receive feedback about the newly composed social data using trackers associated with the newly composed social data.

The social analytic synthesizer module 106 obtains data, including but not limited to social data, from each of the other modules 103, 104, 105 and analyses the data. The social analytic synthesizer module 106 uses the analytic results to generate adjustments for one or more various operations related to any of the modules 103, 104, 105 and 106. The social data obtained by the social analytic synthesizer module 106 may be a subset of the social data contained by the active receiver module, the active composer module, the active transmitter module or may be obtained from third party sources, or both in relation to the data generated from at least one of the modules 103, 104, 105.

In an example embodiment, there are multiple instances of each module. For example, multiple active receiver modules 103 are located in different geographic locations. One active receiver module is located in North America, another active receiver module is located in South America, another active receiver module is located in Europe, and another active receiver module is located in Asia. Similarly, there may be multiple active composer modules, multiple active transmitter modules and multiple social analytic synthesizer modules. These modules will be able to communicate with each other and send information between each other. The multiple modules allows for distributed and parallel processing of data. Furthermore, the multiple modules positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose social data that is transmitted to computing devices within South America. In another example embodiment, social data is obtained in Europe and is obtained in South America, and the social data from the two regions are combined and used to compose social data that is transmitted to computing devices in North America.

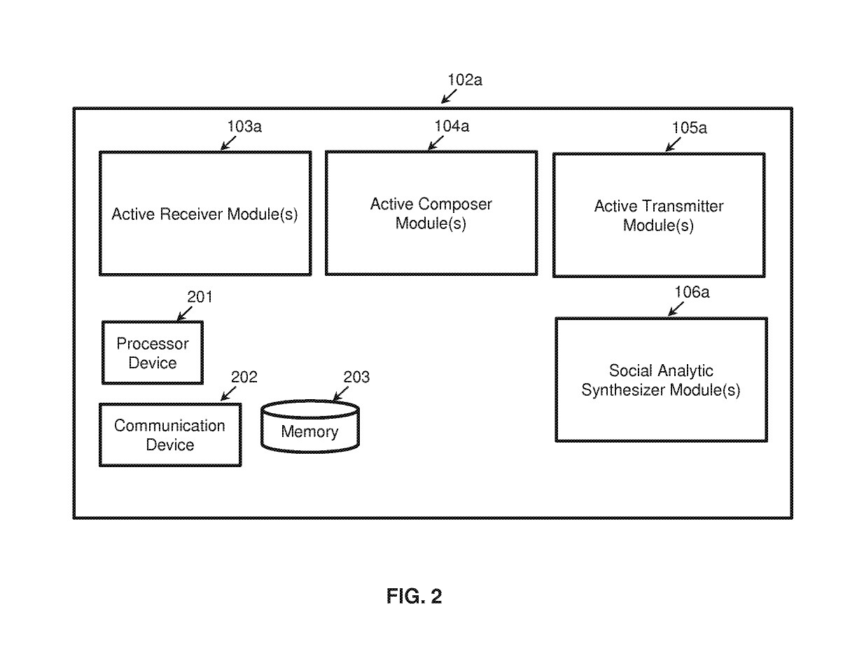

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the active composer module 104a, the active transmitter module 105a, and the social analytic synthesizer module 106a are implemented by software and reside within the same computing device or server system 102a. In other words, the modules may share computing resources, such as for processing, communication and memory.

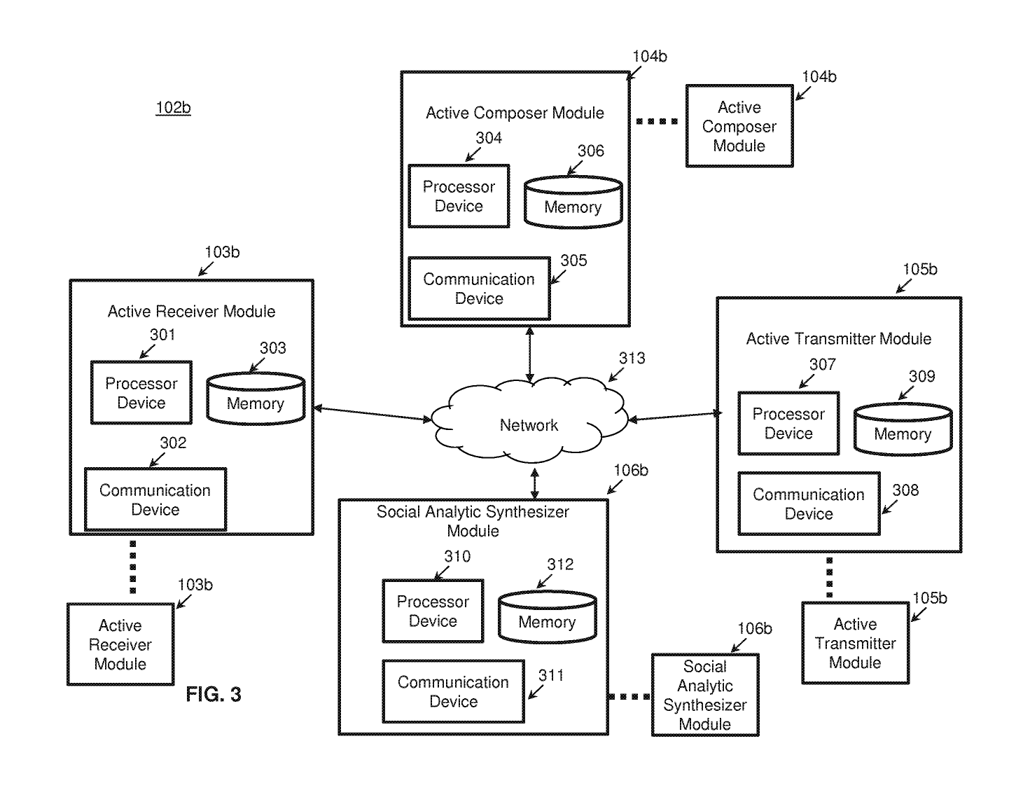

Turning to FIG. 3, another example embodiment of a system 102b is shown. The system 102b includes different modules 103b, 104b, 105b, 106b that are separate computing devices or server systems configured to communicate with each other over a network 313. In particular, the active receiver module 103b includes a processor device 301, a communication device 302, and memory 303. The active composer module 104b includes a processor device 304, a communication device 305, and memory 306. The active transmitter module 105b includes a processor device 307, a communication device 308, and memory 309. The social analytic synthesizer module 106b comprises a processor device 310, a communication device 311, and memory 312.

Although only a single active receiver module 103b, a single active composer module 104b, a single active transmitter module 105b and a single social analytic synthesizer module 106b are shown in FIG. 3, it can be appreciated that there may be multiple instances of each module 103b, 104b, 105b and/or 106b that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors.

Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105, 106, or accessible or connectable thereto. Any application or module herein described may be implemented using computer readable/executable instructions that may be stored or otherwise held by such computer readable media.

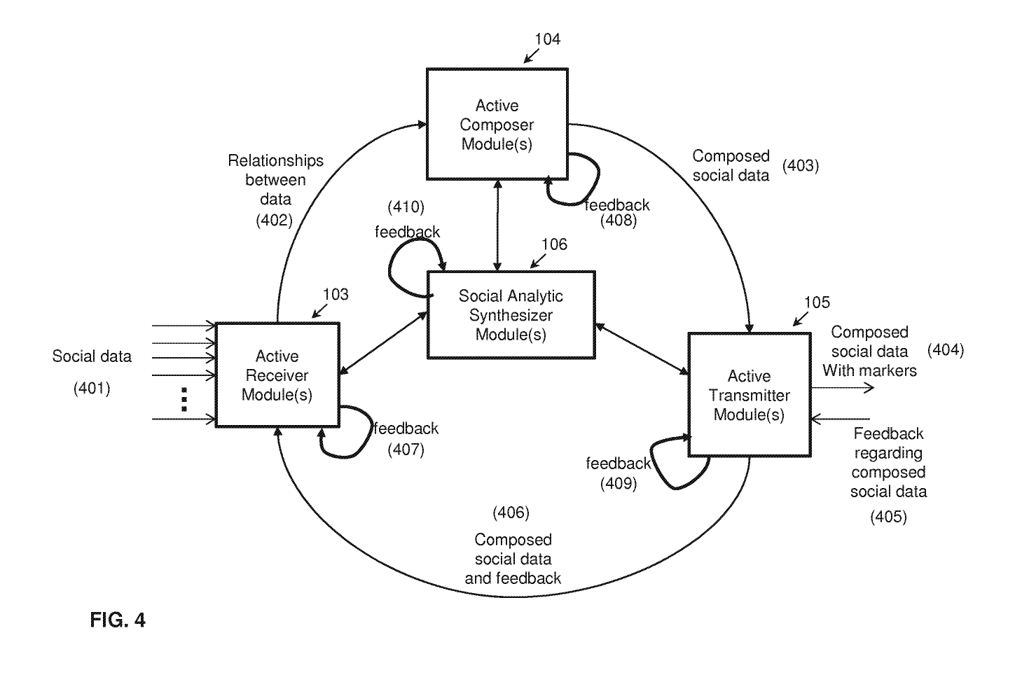

Turning to FIG. 4, the interactions between the modules are shown. The system 102 is configured to listen to data streams, compose automated and intelligent messages, launch automated content, and listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pintrest, blog websites, news websites, company websites, forums, RSS feeds, emails, social networking sites, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The active composer module 104 obtains these relationships 402 and obtains social data corresponding to these relationships. The active composer module 104 uses these relationships and corresponding data to compose new social data 403. The active composer module 104 is also configured to automatically create entire messages or derivative messages, or both. The active composer module 104 can subsequently apply analytics to recommend an appropriate, or optimal, message that is machine-created using various social data geared towards a given target audience.

Continuing with the particular example, the active composer module 104 composes a new text article by combining an existing text article about the car brand and an existing text article about the sports team. In another example, the active composer module composes a new article about the car brand by summarizing different existing articles of the car brand, and includes advertisement about the sports team in the new article. In another example, the active composer module identifies people who have generated social data content about both the sports team and the car brand, although the social data for each topic may be published at different times and from different sources, and combines this social content together into a new social data message.

In another example embodiment, the active composer module may combine video data and/or audio data related to the car brand with video data and/or audio data related to the sports team to compose new video data and/or audio data. Other combinations of data types can be used. In yet another embodiment, the active composer module 104 composes audio and/or video data. The audio and video data could, in one embodiment, be a compilation of audio clips creating a new audio clip and/or a complication of video clips creating a new video clip. Further alternately, the audio/video/text data composed and outputted by the active composer module 104 comprises a compilation of audio, video, and text clips compiled together to create a new combined social data message containing audio, video, and text clips. Additionally, in one aspect, the active composer module 104 further comprises text and audio translation for translating the text and/or audio from a source language format to a target language format as pre-defined. The translation module 1209, in one aspect, is further configured to convert text/audio from local jargon to a target format or from a first language to the local jargon as pre-defined to form the new social data message.

The active transmitter module 105 obtains the newly composed social data 403 and determines a number of factors or parameters related to the transmission of the newly composed social data. The active transmitter module 105 also inserts or adds markers to track people's responses to the newly composed social data. Based on the transmission factors, the active transmitter module transmits the composed social data with the markers 404. The active transmitter module is also configured to receive feedback regarding the composed social data 405, in which collection of the feedback includes use of the markers. The newly composed social data and any associated feedback 406 are sent to the active receiver module 103.

Continuing with the particular example regarding the car brand and the sports team, the active transmitter module 105 determines trajectory or transmission parameters. For example, social networks, forums, mailing lists, websites, etc. that are known to be read by people who are interested in the car brand and the sports team are identified as transmission targets. Also, special events, such as a competition event, like a game or a match, for the sports team are identified to determine the scheduling or timing for when the composed data should be transmitted. Location of targeted readers will also be used to determine the language of the composed social data and the local time at which the composed social data should be transmitted. Markers, such as number of clicks, number of forwards, time trackers to determine length of time the composed social data is viewed, etc., are used to gather information about people's reaction to the composed social data. The composed social data related to the car brand and the sports team and associated feedback are sent to the active receiver module 103.

Continuing with FIG. 4, the active receiver module 103 receives the composed social data and associated feedback 406. The active receiver module 103 analyses this data to determine if there are any relationships or correlations. For example, the feedback can be used to determine or affirm that the relationship used to generate the newly composed social data is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Periodically, or continuously, the social analytic synthesizer module 106 obtains data from the other modules 103, 104, 105 and/or third party sources of data (e.g. related to a particular social data). The social analytic synthesizer module 106 analyses the data to determine what adjustments can be made to the operations performed by each module, including module 106. It can be appreciated that by obtaining data from each of modules 103, 104 and 105, the social analytic synthesizer has greater contextual information compared to each of the modules 103, 104, 105 individually.

The proposed systems and methods described herein relate to receiving and analyzing social data from one or more associated modules (e.g. 103, 104, and 105), the modules for receiving, composing and/or transmitting social data and communicating with external targets of the social data regarding same. The social data can be used in, for example, but is not limited to, the context of continuous social communication. In other words, the system architecture and operations related to the social analytic synthesizer module, described below, may be used with the continuous social communication system described herein, may be used in isolation, or may be used with other systems not described here. ps Social Analytic Synthesizer Module 106—Obtaining Data

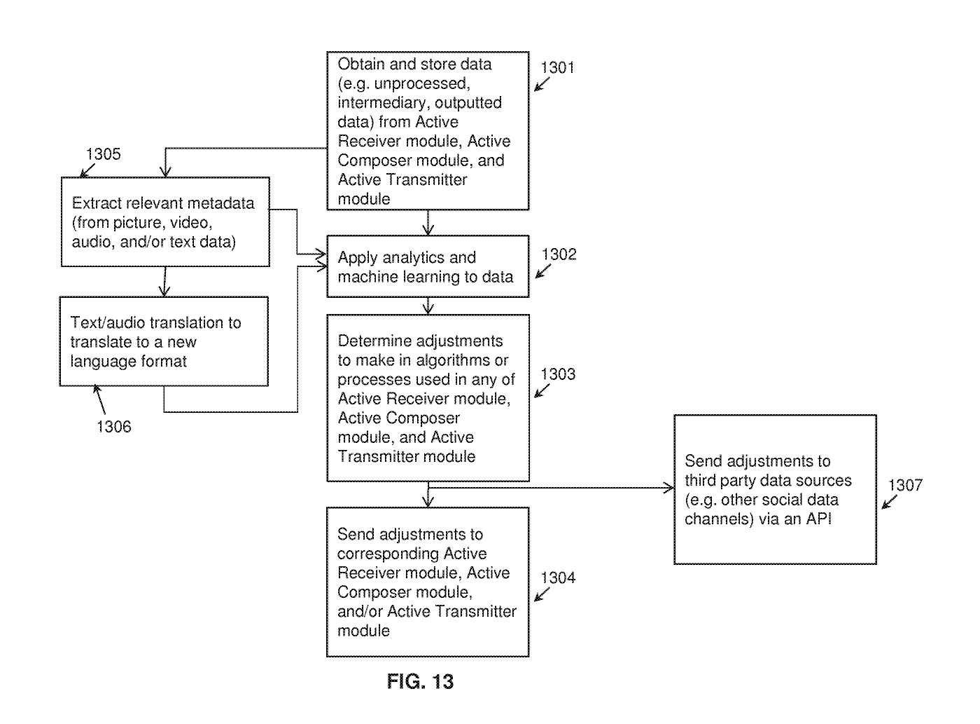

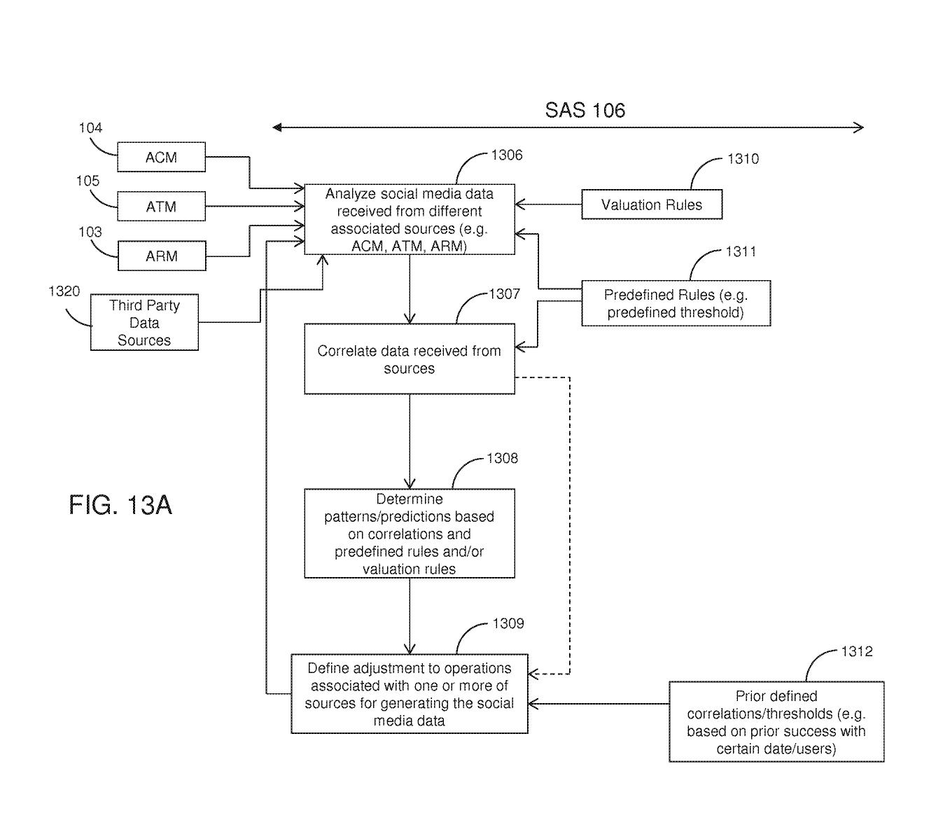

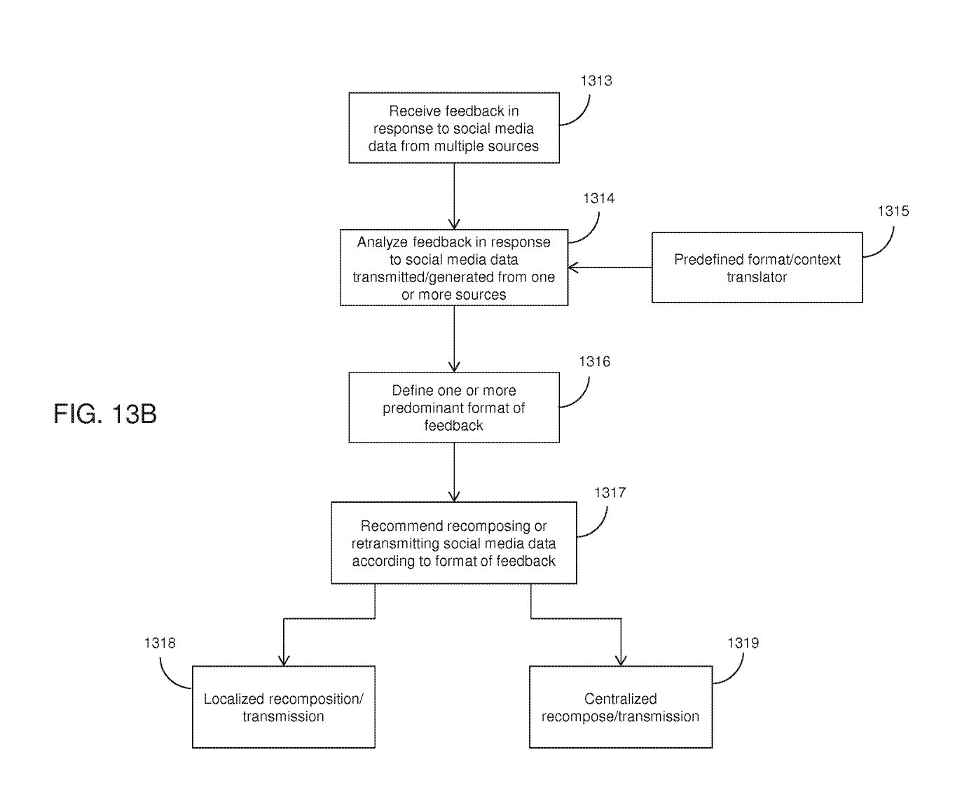

In an example embodiment, the social analytic synthesizer module 106 is configured to request or automatically receive social media data according to predefined criteria. In one aspect, pre-defined criteria (e.g. set of thresholds, pre-defined set of rules for format/content of data) can be set within one or more modules 103, 104, 105 such that when the social media data complies with certain pre-defined rules or threshold criteria for the data then the social media data is automatically forwarded from the respective module to the social analytic synthesizer module 106 after one or more of the pre-defined criteria is met thereby triggering the forwarding of the data to module 106. Furthermore, a threshold is set for data received from third party data sources (e.g. module 1320 in FIG. 13A) such that certain data is forwarded to the synthesizer module 106 and analyzed for relevance of the feedback data or metadata based upon the data meeting pre-defined rules associated with the synthesizer module 106.

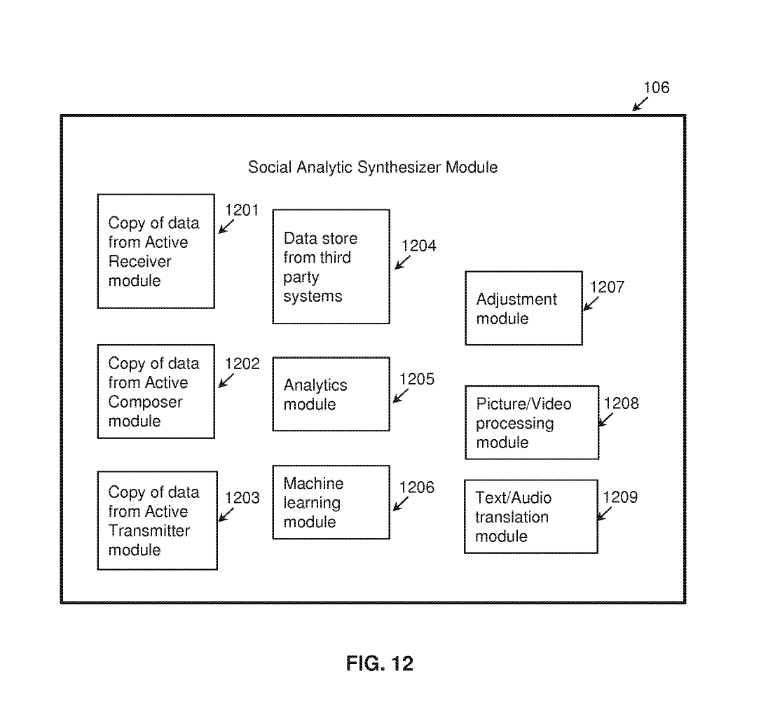

As defined earlier, the social media data obtained at the synthesizer module 106 can comprise one or more audio, text or video data (combined together or in separate data components as pre-defined). The synthesizer module 106 comprises a text/audio translation module 1209 (as described with reference to FIG. 12) which further allows converting text from one language format to a second language format.

As also defined herein, the social media data could be in the form of text, audio, and/or video. For example, the audio and video data could, in one embodiment, be a compilation of audio clips creating a new audio clip and/or a complication of video clips creating a new video clip. Further alternately, the audio/video/text data provided by the other modules comprises a compilation of audio, video, and text clips compiled together to create a new combined social data message containing audio, video, and text clips.

In another aspect, pre-defined criteria (e.g. set of thresholds, pre-defined set of rules for format/content of data) are defined locally within the social analytic synthesizer module(s) 106. In this aspect, the modules 103, 104, 105 are configured to routinely forward their respective social media data to the module 106 for further review. The module 106 accordingly reviews the social media data received and determines based on locally set pre-defined criteria that further analysis on the data is needed and adjustments are made to the operation of the respective modules based on the analysis on the data as will be described.

Accordingly, various thresholds or triggers may be defined locally within each of the modules 103, 104, 105 and/or within the synthesizer module 106 for triggering the social analytic synthesizer module to further analyze the social media data and determine adjustments to the operations of each of the modules 103, 104, and/or 105. Example modifications to the operations of the modules 103, 104, and/or 105 implemented by the synthesizer module 106 can include for example, modifying content of subsequent social media data, format of social media data, target destination(s) of specific types of social media data, additional data to be sent along with the social media data, frequency and/or timing of messages generated by the respective modules. One example of pre-defined criteria can include the degree or extent of positive feedback received in response to a social media data generated or transmitted from modules 103, 104 and/or 105. One measure of positive feedback is for example: the number of times that a particular social media data was re-transmitted or forwarded (e.g. re-tweeted or shared on social media sites). Another measure of positive feedback is the new destination of the messages being forwarded. For example, a social media data message intentioned for one geographical country (e.g. Brazil) may be forwarded by users to other geographical South

American countries. Thus, the social analytic synthesizer modules 106 is configured for receiving feedback regarding the final destination or final destinations of messages generated by the system 102 and detecting the rerouting of the messages. In response, the synthesizer module 106 is configured for altering one or more subsequent social media data to the detected final destination of prior similar messages.

In yet another aspect, the one or more modules 103, 104 and 105 and/or third party social data sources are configured to provide their respective social media data and/or feedback received relating to the data based on defined timing.

### Social Analytic Synthesizer Module 106—Adjusting Operations of System 102

In response, the social media data and/or feedback is forwarded to the social analytic synthesizer module 106 for further altering the operation of the modules 103, 104, and/or 105. For example, subsequent social media data may be tailored to include one or more of: format, content, geographical destination, language, particular target destinations, provided as exemplary adjustments. In one example, the synthesizer module 106 may receive positive feedback regarding social media data transmitted during certain times or dates. Accordingly, the synthesizer module 106 is configured to alter subsequent similar messages to be scheduled according to this knowledge.

In one embodiment, the social analytic synthesizer module 106 is configured for providing the suggested adjustments to the respective module 103, 104, and/or 105. In another embodiment, the social analytic synthesizer module 106 is configured to define the adjusted social media data (e.g. new content, new language, new format, and new target destination) and to forward the new social data to the respective module for transmission to one or more targets.

Continuing with the particular example regarding the car brand and the sports team, the social analytic synthesizer module 106 obtains data that people are responding positively to the newly composed social data object in a second language different than a first language used in the newly composed social data object. Such information can be obtained from the active transmitter module 105 or from the active receiver module 103, or both. Therefore, the social analytic synthesizer module sends an adjustment command to the active composer module 104 to compose new social data about the car brand and the sports team using the second language.

In another example, the social analytic synthesizer module 106 obtains data that positive feedback, about the newly composed social data object regarding the car brand and the sports team, is from particular geographical vicinity (e.g. a zip code, an area code, a city, a municipality, a state, a province, etc.). This data can be obtained by analyzing data from the active receiver module 103 or from the active transmitter module 105, or both. The social analytic synthesizer then generates and sends an adjustment command to the active receiver module 103 to obtain social data about that particular geographical vicinity. Social data about the particular geographical vicinity includes, for example, recent local events, local jargon and slang, local sayings, local prominent people, and local gathering spots. The social analytic synthesizer generates and sends an adjustment command to the active composer module 104 to compose new social data that combines social data about the car brand, the sports team and the geographical vicinity. The social analytic synthesizer generates and sends an adjustment command to the active transmitter module 105 to send the newly composed social data to people located in the geographical vicinity, and to send the newly composed social data during time periods when people are likely to read or consume such social data (e.g. evenings, weekends, etc.).

Continuing with FIG. 4, each module is also configured to learn from its own gathered data and to improve its own processes and decision making algorithms. Currently known and future known machine learning and machine intelligence computations can be used. For example, the active receiver module 103 has a feedback loop 407; the active composer module 104 has a feedback loop 408; the active transmitter module 105 has a feedback loop 409; and the social analytic synthesizer module has a feedback loop 410. In this way, the process in each module can continuously improve individually, and also improve using the adjustments sent by the social analytic synthesizer module 106. This self-learning on a module-basis and system-wide basis allows the system 102 to be completely automated without human intervention.

It can be appreciated that as more data is provided and as more iterations are performed by the system 102 for sending composed social data, then the system 102 becomes more effective and efficient.

Other example aspects of the system 102 are described below.

The system 102 is configured to capture social data in real time.

The system 102 is configured to analyze social data relevant to a business or, a particular person or party, in real time.

The system 102 is configured to create and compose social data that is targeted to certain people or a certain group, in real time.

The system 102 is configured to determine the best or appropriate times to transmit the newly composed social data.

The system 102 is configured to determine the best or appropriate social channels to reach the selected or targeted people or groups.

The system 102 is configured to determine what people are saying about the new social data sent by the system 102.

The system 102 is configured to apply metric analytics to determine the effectiveness of the social communication process.

The system 102 is configured to determine and recommend analysis techniques and parameters, social data content, transmission channels, target people, and data scraping and mining processes to facilitate continuous loop, end-to-end communication.

The system 102 is configured to add N number of systems or modules, for example, using a master-slave arrangement.

It will be appreciated that the system 102 may perform other operations.

In an example embodiment, computer or processor implemented instructions, which are implemented by the system 102, for providing social communication includes obtaining social data. The system then composes a new social data object derived from the social data. It can be appreciated that the new social data object may have exactly the same content of the obtained social data, or a portion of the content of the obtained social data, or none of the content of the obtained social data. The system transmits the new social data object and obtains feedback associated with the new social data object. The system computes an adjustment command using the feedback, wherein executing the adjustment command adjusts a parameter used in the operations performed by the system.

In an example embodiment, the system obtains a social data object using the active receiver module, and the active composer module passes the social data object to the active transmitter module for transmission. Computation and analysis is performed to determine if the social data object is suitable for transmission, and if so, to which party and at which time should the social data object be transmitted.

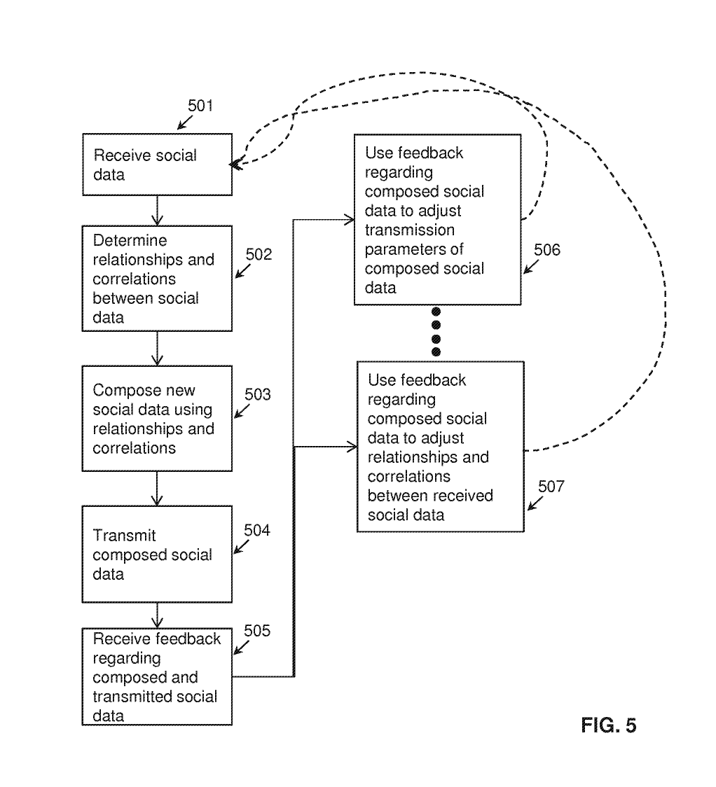

Another example embodiment of computer or processor implemented instructions is shown in FIG. 5 for providing social communication. The instructions are implemented by the system 102. At block 501, the system 102 receives social data. At block 502, the system determines relationships and correlations between social data. At block 503, the system composes new social data using the relationships and the correlations. At block 504, the system transmits the composed social data. At block 505, the system receives feedback regarding the composed social data. At block 506, following block 505, the system uses the feedback regarding the composed social data to adjust transmission parameters of the composed social data. In addition, or in the alternative, at block 507, following block 505, the system uses the feedback regarding the composed social data to adjust relationships and correlations between the received social data. It can be appreciated that other adjustments can be made based on the feedback. As indicated by the dotted lines, the process loops back to block 501 and repeats.

### Active Receiver Module

The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. Further, the active receiver module is able to integrate with other modules, such as the active composer module 104, the active transmitter module 105, and the social analytic synthesizer module 106.

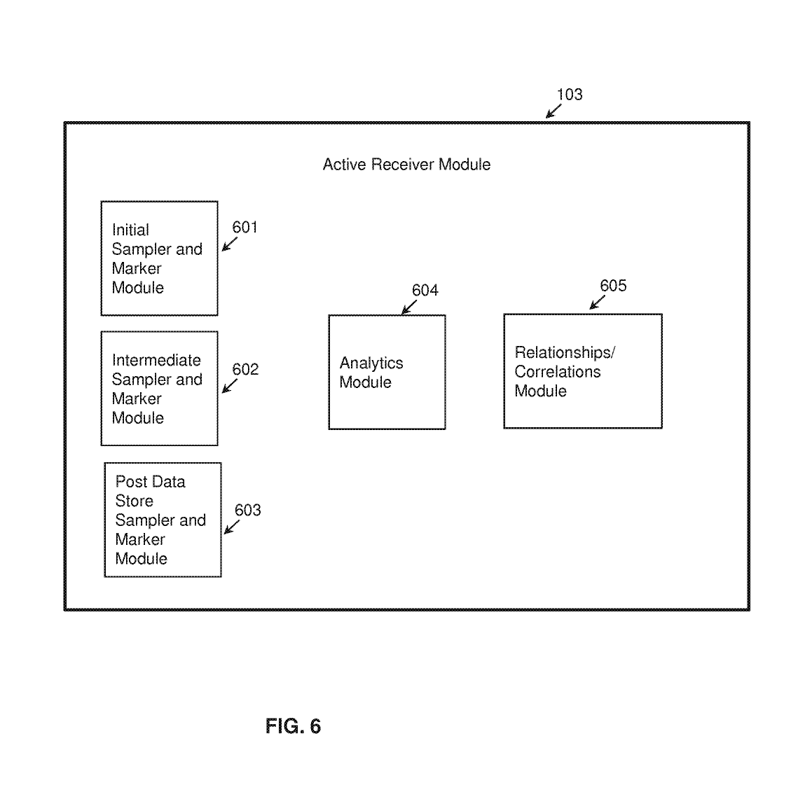

Turning to FIG. 6, example components of the active receiver module 103 are shown. The example components include an initial sampler and marker module 601, an intermediate sampler and marker module 602, a post-data-storage sampler and marker module 603, an analytics module 604, and a relationships/correlations module 605.

To facilitate real-time and efficient analysis of the obtained social data, different levels of speed and granularity are used to process the obtained social data. The module 601 is used first to initially sample and mark the obtained social data at a faster speed and lower sampling rate. This allows the active receiver module 103 to provide some results in real-time. The module 602 is used to sample and mark the obtained data at a slower speed and at a higher sampling rate relative to module 601. This allows the active receiver module 103 to provide more detailed results derived from module 602, although with some delay compared to the results derived from module 601. The module 603 samples all the social data stored by the active receiver module at a relatively slower speed compared to module 602, and with a much higher sampling rate compared to module 602. This allows the active receiver module 103 to provide even more detailed results which are derived from module 603, compared to the results derived from module 602. It can thus be appreciated, that the different levels of analysis can occur in parallel with each other and can provide initial results very quickly, provide intermediate results with some delay, and provide post-data-storage results with further delay.

The sampler and marker modules 601, 602, 603 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This data may be used by the active receiver module 103 and/or the social analytic synthesizer module 106 to determine relationships amongst the social data.

The analytics module 604 can use a variety of approaches to analyze the social data and the associated other data. The analysis is performed to determine relationships, correlations, affinities, and inverse relationships. Non-limiting examples of algorithms that can be used include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 604, for example, obtains the data from the modules 601, 602, and/or 603.

It will be appreciated that inverse relationships between two concepts, for example, is such that a liking or affinity to first concept is related to a dislike or repelling to a second concept.

The relationships/correlations module 605 uses the results from the analytics module to generate terms and values that characterize a relationship between at least two concepts.

The concepts may include any combination of keywords, time, location, people, video data, audio data, graphics, etc.

The relationships module 605 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In another example aspect, the relationships module 605 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. It can be appreciated that there are various ways to correlate topics and users together. Further details are described in U.S. Patent Application No. 61/837,933, filed on Jun. 21, 2013 and titled “System and Method for Analysing Social Network Data”, the entire contents of which are incorporated herein by reference.

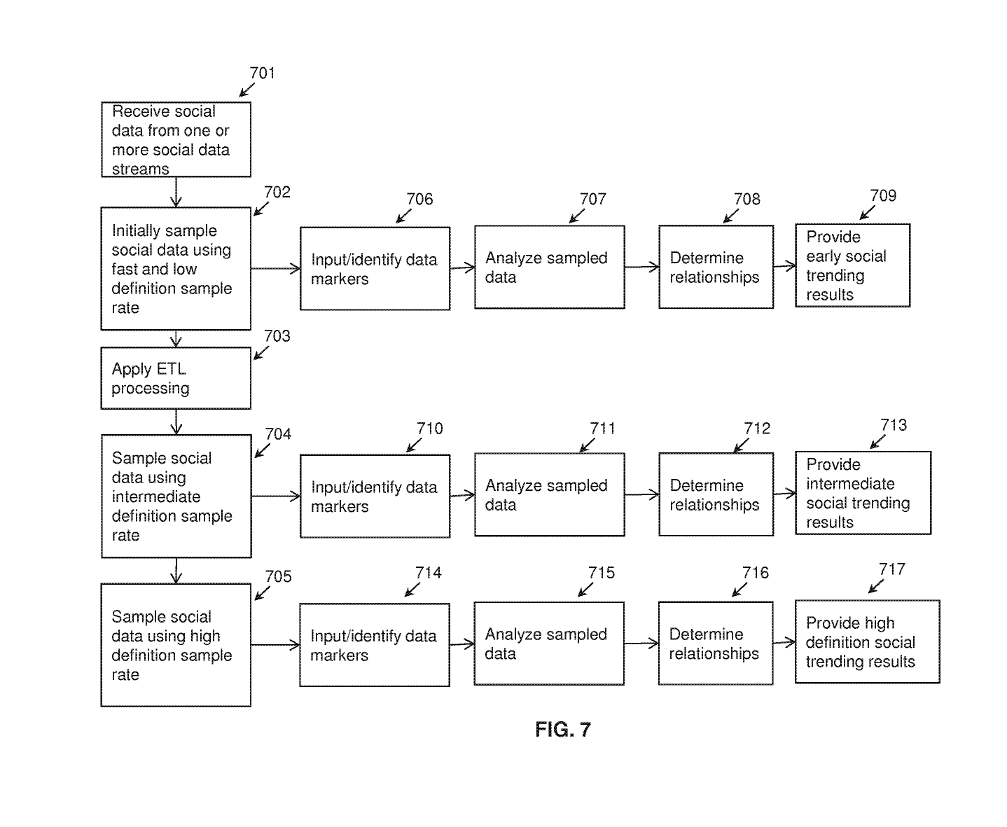

Turning to FIG. 7, example computer or processor implemented instructions are provided for receiving and analysing data according to the active receiver module 103. At block 701, the active receiver module receives social data from one or more social data streams. At block 702, the active receiver module initially samples the social data using a fast and low definition sample rate (e.g. using module 601). At block 703, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 704, the active receiver module samples the social data using an intermediate definition sample rate (e.g. using 601). At block 705, the active receiver module samples the social data using a high definition sample rate (e.g. using module 603). In an example embodiment, the initial sampling, the intermediate sampling and the high definition sampling are performed in parallel. In another example embodiment, the samplings occur in series.

Continuing with FIG. 7, after initially sampling the social data (block 702), the active receiver module inputs or identifies data markers (block 706). It proceeds to analyze the sampled data (block 707), determine relationships from the sampled data (block 708), and use the relationships to determine early or initial social trending results (block 709).

Similarly, after block 704, the active receiver module inputs or identifies data markers in the sampled social data (block 710). It proceeds to analyze the sampled data (block 711), determine relationships from the sampled data (block 712), and use the relationships to determine intermediate social trending results (block 713).

The active receiver module also inputs or identifies data markers in the sampled social data (block 714) obtained from block 705. It proceeds to analyze the sampled data (block 715), determine relationships from the sampled data (block 716), and use the relationships to determine high definition social trending results (block 717).

In an example embodiment, the operations at block 706 to 709, the operations at block 710 to 713, and the operations at block 714 to 717 occur in parallel. The relationships and results from blocks 708 and 709, however, would be determined before the relationships and results from blocks 712, 713, 716 and 717.

It will be appreciated that the data markers described in blocks 706, 710 and 714 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data.

In an example embodiment, the data markers are identified by conducting a preliminary analysis of the sampled data, which is different from the more detailed analysis in blocks 707, 711 and 715. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4×4”, “CR-V”, “Rav4”, and “RDX”. It can be appreciated that other rules for inputting data markers can be used. The inputted data markers can also be used during the analysis operations and the relationship determining operations to detect trends and sentiment.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information.

The active receiver module 103 is configured to propose user segment or target groups based upon the social data and the metadata received.

The active receiver module 103 is configured to proposed or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Active Composer Module

The active composer module 104 is configured to analytically compose and create social data for communication to people. This module may use business rules and apply learned patterns to personalize content. The active composer module is configured, for example, to mimic human communication, idiosyncrasies, slang, and jargon. This module is configured to evaluate multiple social data pieces or objects composed by itself (i.e. module 104), and further configured to evaluate ranks and recommend an optimal or an appropriate response based on the analytics. Further, the active composer module is able to integrate with other modules, such as the active receiver module 103, the active transmitter module 105, and the social analytic synthesizer module 106. The active composer module can machine-create multiple versions of a personalized content message and recommend an appropriate, or optimal, solution for a target audience.

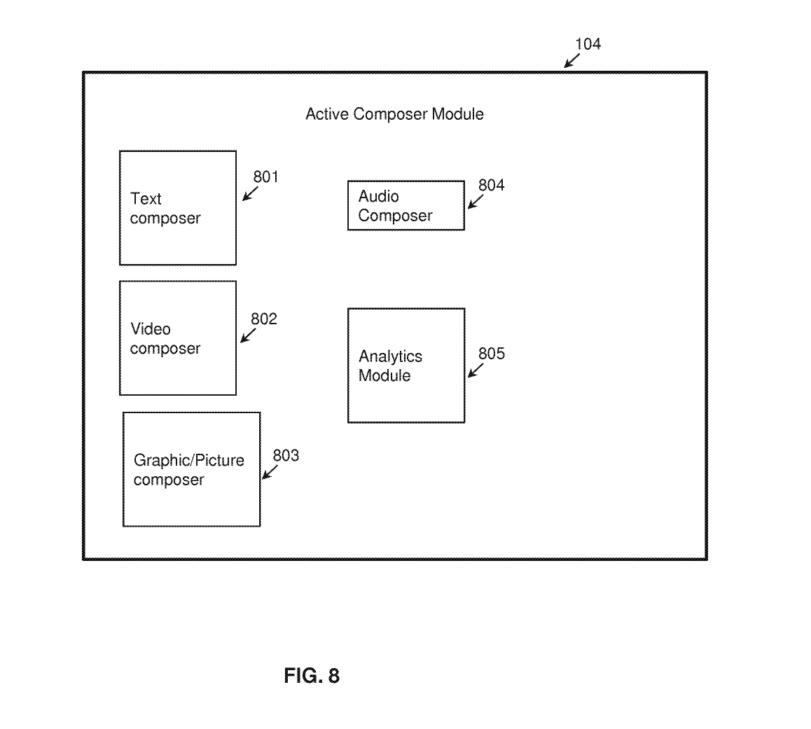

Turning to FIG. 8, example components of the active composer module 104 are shown. Example components include a text composer module 801, a video composer module 802, a graphics/picture composer module 803, an audio composer 804, and an analytics module 805. The composer modules 801, 802, 803 and 804 can operate individually to compose new social data within their respective media types, or can operate together to compose new social data with mixed media types.

The analytics module 805 is used to analyse the outputted social data, identify adjustments to the composing process, and generate commands to make adjustments to the composing process.

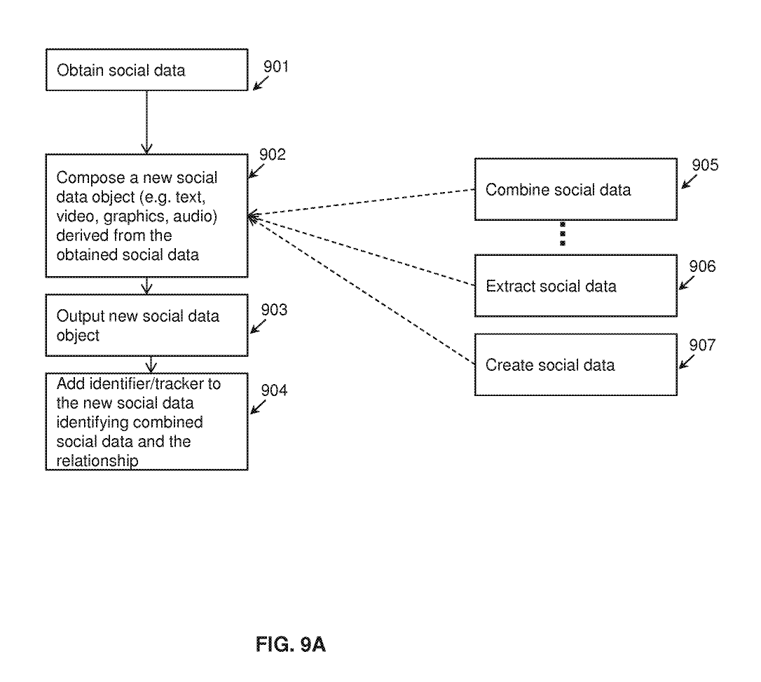

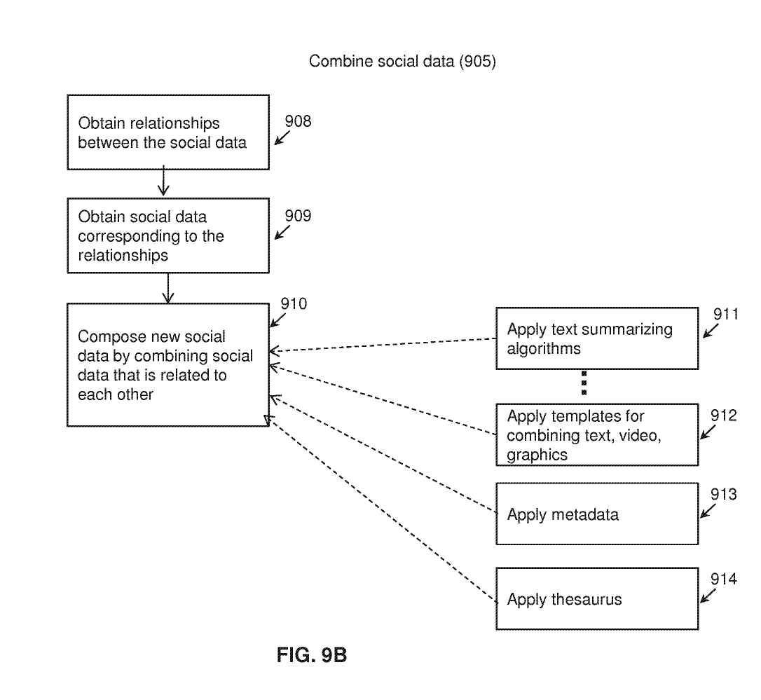

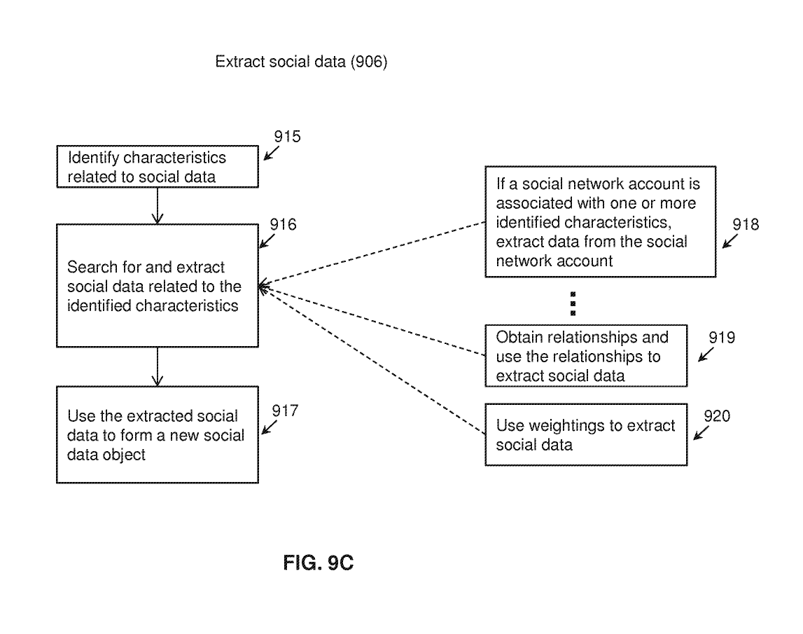

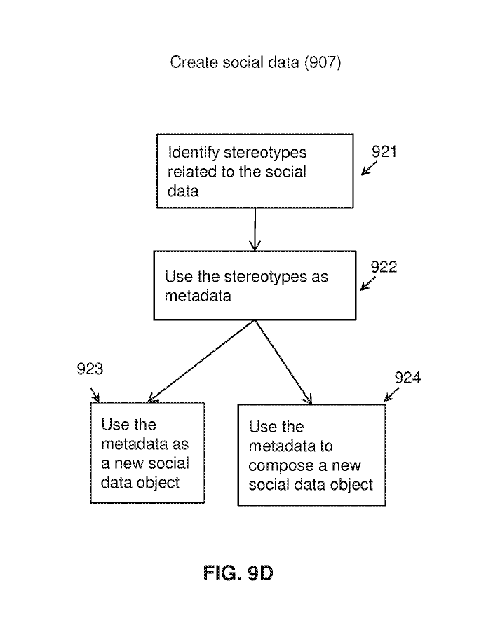

Turning to FIG. 9A, example computer or processor implemented instructions are provided for composing social data according the module 104. The active composer module obtains social data, for example from the active receiver module 103 (block 901). The active composer module then composes a new social data object (e.g. text, video, graphics, audio) derived from the obtained social data (block 902).

Various approaches can be used to compose the new social data object, or new social data objects. For example, social data can be combined to create the new social data object (block 905), social data can be extracted to create the new social object (block 906), and new social data can be created to form the new social data object (block 907). The operations from one or more of blocks 905, 906 and 907 can be applied to block 902. Further details in this regard are described in FIGS. 9B, 9C and 9D.

Continuing with FIG. 9A, at block 903, the active composer module outputs the composed social data. The active composer module may also add identifiers or trackers to the composed social data, which are used to identify the sources of the combined social data and the relationship between the combined social data.

Turning to FIG. 9B, example computer or processor implemented instructions are provided for combining social data according to block 905. The active composer module obtains relationships and correlations between the social data (block 908). The relationships and correlations, for example, are obtained from the active receiver module. The active composer module also obtains the social data corresponding to the relationships (block 909). The social data obtained in block 909 may be a subset of the social data obtained by the active receiver module, or may be obtained by third party sources, or both. At block 910, the active composer module composes new social data (e.g. a new social data object) by combining social data that is related to each other.

It can be appreciated that various composition processes can be used when implementing block 910. For example, a text summarizing algorithm can be used (block 911). In another example, templates for combining text, video, graphics, etc. can be used (block 912).

In an example embodiment, the templates may use natural language processing to generate articles or essays. The template may include a first section regarding a position, a second section including a first argument supporting the position, a third section including a second argument supporting the position, a fourth section including a third argument supporting the position, and a fifth section including a summary of the position. Other templates can be used for various types of text, including news articles, stories, press releases, etc.

Natural language processing catered to different languages can also be used. Natural language generation can also be used. It can be appreciated that currently know and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 9B, metadata obtained from the active receiver module, or obtained from third party sources, or metadata that has been generated by the system 102, may also be applied when composing the new social data object (block 913). Furthermore, a thesaurus database, containing words and phrases that are synonymous or analogous to keywords and key phrases, can also be used to compose the new social data object (block 914). The thesaurus database may include slang and jargon.

Turning to FIG. 9C, example computer or processor implemented instructions are provided for extracting social data according to block 906. At block 915, the active composer module identifies characteristics related to the social data. These characteristics can be identified using metadata, tags, keywords, the source of the social data, etc. At block 916, the active composer module searches for and extracts social data that is related to the identified characteristics.

For example, one of the identified characteristics is a social network account name of a person, an organization, or a place. The active composer module will then access the social network account to extract data from the social network account. For example, extracted data includes associated users, interests, favourite places, favourite foods, dislikes, attitudes, cultural preferences, etc. In an example embodiment, the social network account is a Linkedln account or a Facebook account. This operation (block 918) is an example embodiment of implementing block 916.

Another example embodiment of implementing block 916 is to obtain relationships and use the relationships to extract social data. Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

Another example embodiment of implementing block 916 is to use weighting to extract social data (block 920). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data can be used.

At block 917, the extracted social data is used to form a new social data object.

Turning to FIG. 9D, example computer or processor implemented instructions are provided for creating social data according to block 907. At block 921, the active composer module identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the composer module, gains experience obtaining data and feedback regarding the social communications being transmitted, the active composer module is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 9D, the stereotypes are used as metadata (block 922). In an example embodiment, the metadata is the new social data object (block 923), or the metadata can be used to derive or compose a new social data object (block 924).

It can be appreciated that the methods described with respect to blocks 905, 906 and 907 to compose a new social data object can be combined in various way, though not specifically described herein. Other ways of composing a new social data object can also be applied.

In an example embodiment of composing a social data object, the social data includes the name “Chris Farley”. To compose a new social data object, social data is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new social data object comprising the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farley could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

The active composer module 104 is configured to operate with little or no human intervention.

### Active Transmitter Module

The active transmitter module 105 analytically assesses preferred or appropriate social data channels to communicate the newly composed social data to certain users and target groups. The active transmitter module also assesses the preferred time to send or transmit the newly composed social data.

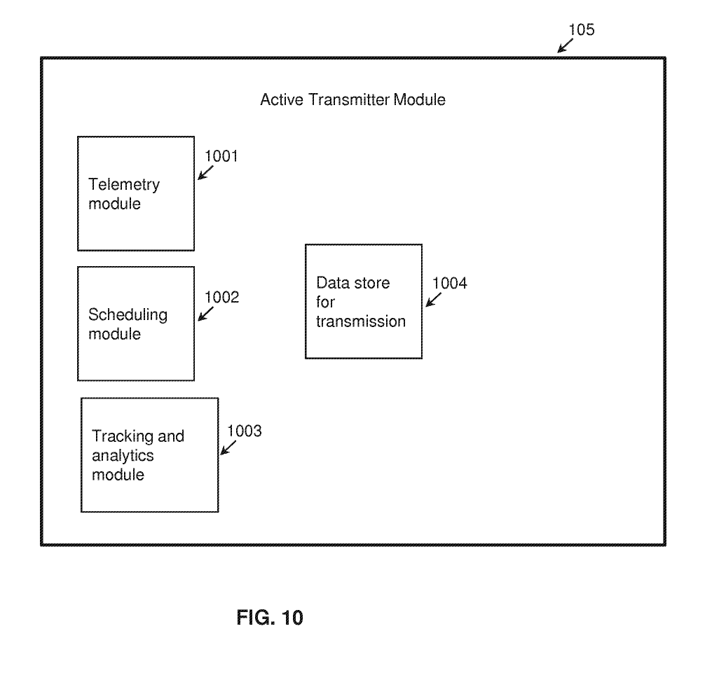

Turning to FIG. 10, example components of the active transmitter module 105 are shown. Example components include a telemetry module 1001, a scheduling module 1002, a tracking and analytics module 1003, and a data store for transmission 1004. The telemetry module 1001 is configured to determine or identify over which social data channels a certain social data object should be sent or broadcasted. A social data object may be a text article, a message, a video, a comment, an audio track, a graphic, or a mixed-media social piece. For example, a social data object about a certain car brand should be sent to websites, RSS feeds, video or audio channels, blogs, or groups that are viewed or followed by potential car buyers, current owners of the car brand and past owners of the car brand. The scheduling module 1002 determines a preferred time range or date range, or both, for sending a composed social data object. For example, if a newly composed social data object is about stocks or business news, the composed social data object will be scheduled to be sent during working hours of a work day. The tracking and analytics module 1003 inserts data trackers or markers into a composed social data object to facilitate collection of feedback from people. Data trackers or markers include, for example, tags, feedback (e.g. like, dislike, ratings, thumb up, thumb down, etc.), number of views on a web page, etc.

The data store for transmission 1004 stores a social data object that has the associated data tracker or marker. The social data object may be packaged as a “cart”. Multiple carts, having the same social data object or different social data objects, are stored in the data store 1004. The carts are launched or transmitted according to associated telemetry and scheduling parameters. The same cart can be launched multiple times. One or more carts may be organized under a campaign to broadcast composed social data. The data trackers or markers are used to analyse the success of a campaign, or of each cart.

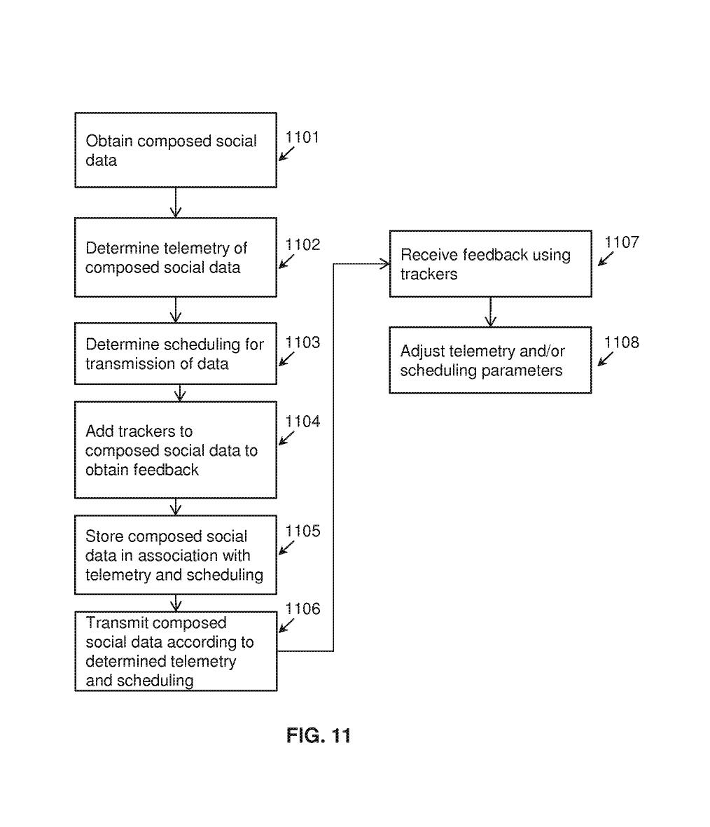

Turning to FIG. 11, example computer or processor implemented instructions are provided for transmitting composed social data according the active transmitter module 105. At block 1101, the active transmitter module obtains the composed social data. At block 1102, the active transmitter module determines the telemetry of the composed social data. At block 1103, the active transmitter module determines the scheduling for the transmission of the composed social data. Trackers, which are used to obtain feedback, are added to the composed social data (block 1104), and the social data including the trackers are stored in association with the scheduling and telemetry parameters (block 1105). At the time determined by the scheduling parameters, the active transmitter module sends the composed social data to the identified social data channels, as per the telemetry parameters (block 1106).

Continuing with FIG. 11, the active transmitter module receives feedback using the trackers (block 1107) and uses the feedback to adjust telemetry or scheduling parameters, or both (block 1108).

Other example aspects of the active transmitter module 105 are provided below.

The active transmitter module 105 is configured to transmits messages and, generally, social data with little or no human intervention

The active transmitter module 105 is configured to uses machine learning and analytic algorithms to select one or more data communication channels to communicate a composed social data object to an audience or user(s). The data communication channels include, but are not limited to, Internet companies such as FaceBook, Twitter, and Bloomberg. Channel may also include traditional TV, radio, and newspaper publication channels.

The active transmitter module 105 is configured to automatically broaden or narrow the target communication channel(s) to reach a certain target audience or user(s).

The active transmitter module 105 is configured to integrate data and metadata from third party companies or organizations to help enhance channel targeting and user targeting, thereby improving the effectiveness of the social data transmission.

The active transmitter module 105 is configured to apply and transmit unique markers to track composed social data. The markers track the effectiveness of the composed social data, the data communication channel's effectiveness, and ROI (return on investment) effectiveness, among other key performance indicators.

The active transmitter module 105 is configured to automatically recommend the best time or an appropriate time to send/transmit the composed social data.

The active transmitter module 105 is configured to listen and interpret whether the composed social data was successfully received by the data communication channel(s), or viewed/consumer by the user(s), or both.

The active transmitter module 105 is configured to analyse the user response of the composed social data and automatically make changes to the target channel(s) or user(s), or both. In an example, the decision to make changes is based on successful or unsuccessful transmission (receipt by user).

The active transmitter module 105 is configured to filter out certain data communication channel(s) and user(s) for future or subsequent composed social data transmissions.

The active transmitter module 105 is configured to repeat the transmission of previously sent composed social data for N number of times depending upon analytic responses received by the active transmitter module. The value of N in this scenario may be analytically determined.

The active transmitter module 105 is configured to analytically determine a duration of time between each transmission campaign.

The active transmitter module 105 is configured to apply metadata from the active composer module 104 to the transmission of the composed social data, in order to provide further business information enrichment. The metadata includes, but is not limited to, geo data, temporal data, business driven characteristics, unique campaign IDs, keywords, hash tags or equivalents, analytic driven characteristics, etc.

The active transmitter module 105 is configured to scale in size, for example, by using multiple active transmitter modules 105. In other words, although one module 105 is shown in the figures, there may be multiple instances of the same module to accommodate large scale transmission of data.

### Social Analytic Synthesizer Module

The social analytic synthesizer module 106 is configured to perform machine learning, analytics, and to make decisions according to business driven rules. The results and recommendations determined by the social analytic synthesizer module 106 are intelligently integrated with any one or more of the active receiver module 103, the active composer module 104, and the active transmitter module 105, or any other module that can be integrated with the system 102. This module 106 may be placed or located in a number of geo locations, facilitating real time communication amongst the other modules. This arrangement or other arrangements can be used for providing low latency listening, social content creation and content transmission on a big data scale.

The social analytic synthesizer module 106 is also configured to identify unique holistic patterns, correlations, and insights. In an example embodiment, the module 106 is able to identify patterns or insights by analysing all the data from at least two other modules (e.g. any two or more of modules 103, 104 and 105), and these patterns or insights would not have otherwise been determined by individually analysing the data from each of the modules 104, 104 and 105. The feedback or an adjustment command is provided by the social analytic synthesizer module 106, in an example embodiment, in real time to the other modules. Over time and over a number of iterations, each of the modules 103, 104, 105 and 106 become more effective and efficient at continuous social communication and at their own respective operations.

Turning to FIG. 12, example components of the social analytic synthesizer module 106 are shown. Example components include a copy of data from the active receiver module 1201, a copy of data from the active composer module 1202, and a copy of data from the active transmitter module 1203. These copies of data include the inputted data obtained by each module, the intermediary data, the outputted data of each module, the algorithms and computations used by each module, the parameters used by each module, etc. Preferably, although not necessarily, these data stores 1201, 1202 and 1203 are updated frequently. In an example embodiment, the data from the other modules 103, 104, 105 are obtained by the social analytic synthesizer module 106 in real time as new data from these other modules become available.

Continuing with FIG. 12, example components also include a data store from a third party system 1204, an analytics module 1205, a machine learning module 1206 and an adjustment module 1207. The analytics module 1205 and the machine learning module 1206 process the data 1201, 1202, 1203, 1204 using currently known and future known computing algorithms to make decisions and improve processes amongst all modules (103, 104, 105, and 106).

As described earlier, the data received at the synthesizer module 106 from the other modules 1201, 1202, 1203 can be in the form of audio, video and/or text. For example, various combinations of audio, video and/or text could be received at the synthesizer module 106. The audio and video data could, in one embodiment, be a compilation of audio clips provided as a single audio clip and/or a complication of video clips provided as a single video clip. Further alternately, the audio/video/text data composed and provided by the other modules comprises a compilation of audio, video, and text clips compiled together to create a new combined social data message containing audio, video, and text clips.

The analytics module 1205 can communicate with the machine learning module 1206 and use a variety of approaches to analyze the social data and the associated other data as received from modules 103, 104, and 105. The analysis is performed to determine relationships, correlations, affinities, and inverse relationships within the data provided independently from each module and to cross-correlate the data from each one of the modules 103, 104 and 105 with the remaining other ones of the modules 103, 104 and 105. Non-limiting examples of algorithms that can be used to determine the relationships amongst the data include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data obtained from the modules 103, 104 and/or 105 (as well as previous data from the synthesizer module 106).

The adjustment module 1207 generates adjustment commands based on the results from the analytics module and the machine learning module. The adjustment commands are then sent to the respective modules (e.g. any one or more of modules 103, 104, 105, and 106).

In an example embodiment, data from a third party system 1204 can be from another social network, such as Linkedln, Facebook, Twittter, etc.

Other example aspects of the social analytic synthesizer module 106 are below.

Continuing with FIG. 12, example components also include a picture/video processing module 1208 and a text/audio translation module 1209. In one aspect, the picture and video processing module 1208 is configured to recognize features within the picture or video data and extract data/metadata accordingly. In one example, the social media metadata extracted by the picture/video processing module is extracted for being relevant to other social media data being analyzed by the synthesizer module 106 (e.g. as received from other sources or in different formats) or to a specific ad campaign or pre-defined topic of interest. Preferably, the synthesizer module is further configured to adjust the metadata extracted by the picture/video processing module in dependence upon feedback received from prior transmitted social data. Other criteria and rules can be pre-defined and dynamically updated by the synthesizer module 106 for extracting the desired data/metadata from the picture/video processing module and/or the text/audio translation module. The synthesizer module 106, in one aspect is configured to comprise additional rules and thresholds for defining the type, format, content of data/metadata extracted by the picture/video processing module 1208.

The synthesizer module 106 further comprises the text/audio translation module 1209 for translating text/audio from a source language format to a destination language format. The text/audio translation module 1209 may also be configured to translate local jargon and hybrid formats of language into a destination language format according to pre-defined rules and instruction.

Accordingly, the data/metadata extracted from modules 1208 and/or 1209 is fed to the other modules (103, 104, 105 and 106) for improving processes amongst all modules (103, 104, 105, and 106) and/or to third party data sources.

The social analytic synthesizer module 106 is configured to integrate data in real time from one or more sub systems and modules, included but not limited to the active receiver module 103, the active composer module 104, and the active transmitter module 105. External or third party systems can be integrated with the module 106.

The social analytic synthesizer module 106 is configured to apply machine learning and analytics to the obtained data to search for “holistic” data patterns, correlations and insights.

The social analytic synthesizer module 106 is configured to feedback, in real time, patterns, correlations and insights that were determined by the analytics and machine learning processes (e.g. analytics module 1205 and/or machine learning module 1206). The feedback is directed to the modules 103, 104, 105, and 106 and this integrated feedback loop improves the intelligence of each module and the overall system 102 over time. In yet another aspect, the synthesizer module 106 is configured to directly alter subsequent social media data generated by the system 102 prior to transmission to end users based on the criteria that the subsequent social media data is similar to prior social media data from which patterns, correlations and/or insights were determined. As mentioned above, the feedback can also be translated using the text and audio translation module 1209 to a target language format. For example, the translated text, audio, video, picture can be provided to the modules 103, 104, 105 and 106 for further processing and adjusting operations of the modules according to the feedback information.

The social analytic synthesizer module 106 is configured to scale the number of such modules. In other words, although the figures show one module 106, there may be multiple instances of such a module 106 to improve the effectiveness and response time of the feedback.

The social analytic synthesizer module 106 is configured to operate automatically (without any user input), and/or semi-automatically (user input for defining business rules and/or criteria for triggering retrieval of social data and/or triggering adjustment of operations of system 102).

Turning to FIG. 13, example computer or processor implemented instructions are provided for analysing data and providing adjustment commands based on the analysis, according to module 106. At block 1301, the social analytic synthesizer module obtains and stores data from the active receiver module, the active composer module and the active transmitter module. Analytics and machine learning are applied to the data (block 1302). The social analytic synthesizer determines adjustments to make in the algorithms or processes used in any of the active receiver module, active composer module, and the active transmitter module (block 1303). The adjustments, or adjustment commands, are then sent to the corresponding module or corresponding modules (block 1304). Other exemplary instructions are shown at FIG. 13, where in one embodiment; the social analytic synthesizer module is configured to extract relevant metadata from picture, video, audio and/or text data as shown in step 1305 as received at step 1301 from various other modules. As described herein, the metadata extracted at step 1305 can depend upon pre-defined rules and criteria for extracting relevant metadata. In another aspect, the metadata extracted at step 1305 can further comprise determining content, and type of data extracted by the other modules at step 1301 and extracting related content. In yet another aspect, the metadata extracted at step 1305 is further dependent upon feedback and adjustments calculated at step 1303 in dependence upon data analyzed from the other modules. In yet another embodiment, the extracted data is further translated at step 1306 from a source language format to a new language format as defined according to pre-defined criteria or feedback received at the synthesizer module (e.g. from prior analysis at step 1302 and 1303).

In yet a further embodiment, the adjustments, or adjustment commands, are sent to the corresponding third party data sources (block 1307) via an API (application programming interface). For example, in this embodiment, the adjustments alter the generation, composition and transmission of social data messages by a third party source (e.g. another social communication data channel).

### Social Analytic Synthesizer Module-Operation

Turning to FIG. 13A, is shown yet another flow diagram illustrating example computer or processor implemented instructions provided for analysing data and providing adjustment commands based on the analysis, according to module 106. As shown in FIG. 3, preferably, the computer executable instructions are stored in a memory 312 or external memory for execution by one or more processors (e.g. processor devices 310, 301, 304, 307).

Referring to FIG. 13A, the synthesizer module 106 is configured for receiving social media data from two or more other sources of the system 102. The sources include, the active receiver module 103 (also referred to as ARM), the active composer module 104 (also referred to as ACM), and the active transmitter module 105 (also referred to as ATM).

Referring to FIG. 13A, at step 1306, the synthesizer module 106 is configured to analyze social media data received from multiple sources 103, 104, 105 and/or third party data sources 1320 (e.g. alternate social data communication channels). The module 106 is configured to apply one or more valuation rules 1310 to the social media retrieved from the sources. The valuation rules 1310 can define for example, a weighted value to particular social media data that is considered to be of higher significance than other social media data for defining relationships, patterns, correlations, trends. For example, the valuation rules 1310 can define a higher weighting to data associated with certain content or originator or geographical region or groups of users or type of message. Similarly, the valuation rules 1310 can define a higher weighting to data associated with one of the module 103, 104 or 105 over the other modules.

Furthermore, referring to FIG. 13A, pre-defined rules 1311 are applied to facilitate analyzing the social media data at step 1306. That is, as described earlier, the pre-defined rules comprise thresholds and other criteria that are used to filter out unwanted social media data and provide importance to other social media data obtained from the sources. The pre-defined rules can also be set on each module 103, 104, 105 such as to prevent inundating the synthesizer module with unwanted data. Therefore, the pre-defined rules 1311 can use pre-defined rules to determine whether the data should be considered for further analysis by the synthesizer module. The pre-defined criteria can include for example, the language of the social data, the format, type or content of the data, the originator of the social media data. Other pre-defined criteria as discussed earlier can include the degree to which positive feedback has been obtained from users regarding the social media data or similar prior data. As mentioned earlier, one measure of positive feedback is whether prior social media data of the same type or content or language has been retweeted or re-posted or forwarded or shared among social media users via social media mobile applications or websites. Positive feedback can also be provided by the active receiver module 103 as detecting the number of hits or clicks or selections of a social media data to imply that the reaction to the particular social media data is positive.

Referring to FIG. 13A, at step 1307, the synthesizer module 106 correlates (and cross-correlates) data received from multiple source modules (e.g. receiver, composer and/or transmitter modules). That is the data is correlated internally and externally across the modules to define relationships, correlations, affinities, and inverse relationships. The correlation can include for example machine learning and analytics to the obtained data to search for “holistic” data patterns, correlations and insights into trends.

Non-limiting examples of algorithms for implementing the correlation at step 1307 can include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data.

In one aspect, once the correlated data is retrieved at step 1307, predefined rules 1311 (e.g. predefined thresholds) are applied to the correlated data to filter out unwanted data and expose the patterns that are more relevant to the module 106. In one aspect, the pre-defined rules can be user defined (e.g. via user input on a user interface associated with the system 102) or based on prior defined data that received positive feedback.

At step 1308, the patterns and predictions are thus detected and generated based upon the predefined rules. These patterns can expose important conversations and trends in the social media data. In one aspect, the exposed patterns can define trending topics of conversation or influencer user(s) that are influencing trends or topics in the social media data.

At step 1309, the module 106 generates one or more adjustments for applying to operations associated with one or more source modules (e.g. 103, 104, and 105). These adjustment commands can be recommendations for altering the operations of the modules (103, 104 or 105) or alternatively, the synthesizer module 106 can be configured to directly generate new social media data according to the recommendations and to provide the newly composed data to the relevant modules (e.g. 103, 104 or 105) for transmitting to the desired users.

In one aspect, the module 106 stores the adjustment information (e.g. in memory 312), these prior defined adjustments 1312 are then applied to the defined adjustments at step 1309 to further tailor the adjustments according to prior knowledge. For example, the prior adjustments may further indicate that sending the particular type of content resonates with particular people/users and accordingly the synthesizer module 106 then modifies the adjustments 1309 to include the prior adjustment knowledge 1312.

In one aspect, the synthesizer module 106 can indicate to the active composer module 104 to compose new content/data according to the patterns determined at steps 1307 and 1308.

In another aspect, the synthesizer module 106 can indicate to the active transmitter module 105 to redirect transmission of social media data to new communication channels (e.g. new users or target destinations) according to the patterns indicated at steps 1307 and 1308.

In another aspect, the synthesizer module 106 can direct the active receiver module to: translate text from local jargon to another language according to the patterns located at step 1307 and 1308; to identify relationships amongst the concepts based on determined patterns located at steps 1307 and 1308; to listen for specific types of data or originating from certain sources according to the patterns identified at steps 1307 and 1308. In another aspect, the active receiver module and/or synthesizer module comprises language translation module (e.g. similar to block 1209 described with respect to the synthesizer module) for recognizing and translating text, picture, video, and audio into a desired language and for further processing and data/metadata retrieval for subsequent analysis thereon. The language translation module can further be configured to be adjusted according to the success and viewability rate of prior submitted social data messages as received in the feedback to the synthesizer module 106.

Accordingly, the module 106 is self-optimizing for improving the operations of the modules 103, 104 and 105 and generating content to targets that is likely to be well received (e.g. positive feedback) and/or forwarded to other users as well and/or become a trending topic.

Referring to FIG. 13A, the steps further include executing the adjustment command at step 1309 and repeating the method at step 1306.

Example adjustments provided at step 1309 can include the following non-limiting examples.

Data analyzed at step 1306 illustrates that the transmitter module 105 and/or receiver module 103 has received positive feedback from a number of users within a particular geographic region regarding a social media data message. Accordingly, at step 1306, the synthesizer module 106 is configured to send recommendations to the active transmitter module 105 to expand directional transmission to include the particular geographic region in transmitting subsequent similar messages.

In another example, the active receiver module 103 detects that a first social media data message (e.g. an advertising campaign) previously transmitted by the transmitter module 105 about green shoes is being re-posted or re-transmitted (e.g. retweeted) elsewhere such as to South Vietnam. The synthesizer module 106 then translates the data (e.g. translate from local jargon or language) and then recommends to the composer module 104 to recompose the first message according to local jargon or language. The composer module 104 may also be directed to add in additional information and content that is tailored to South Vietnam based on prior intelligence gathered by the synthesizer module 106 on this region. The transmitter module 105 is then directed by the synthesizer module 106 and/or the composer module 104 to transmit the newly composed social data to South Vietnam. In this manner, the synthesizer module 106 modifies the transmission path and content of the advertising campaign.

In yet another example, the composer module 104 and the receiver module 103 may detect that the content of a first social media data previously transmitted is being updated to a new content. This can be detected for example at steps 1306 and 1307 of FIG. 13A. Therefore, based on the pattern of the new content, the synthesizer module 106 can recommend to the composer module 104 to recompose the first social media data based on the patterns to compose a new social media data for transmission via the transmitter module 105.

In yet another example, the composer module 104, which defines the content of social media data messages provides feedback to the synthesizer module 106 indicating that there are high frequency updates made to templates associated with defining the content (e.g. user defined or via feedback relating to prior sent messages). The transmitter module 105 can further indicate the location (e.g. user or groups of users) associated with the content updates.

Accordingly, the synthesizer module 106 then provides an adjustment to the composer module 104 indicating how/when to update the social media data content based on the feedback information (e.g. to update the content to include the desired content that is reflected in the feedback) as provided by the composer module 104 and the transmitter module 105.

Conversely, the social analytic synthesizer module 106 detects from the active receiver module 103 and active transmitter module 105 that a social media data message has received a low number of hits or clicks or selections (e.g. indicative of negative feedback). Accordingly, the synthesizer module 106 is configured to recommend to the composer module 104 to alter the content and/or destination of the message via the transmitter module 105.

Referring to FIG. 13B, shown is a flow diagram depicting exemplary steps of computer executable or processor implemented instructions by the synthesizer module 106 for determining adjustments for any of the processes implemented by the active receiver module 103, the active composer module 104, and the active transmitter module 105 based upon feedback received from one or more modules.

At step 1313, feedback is received in response to social media data from multiple sources (e.g. active receiver module 103, the active composer module 104, and the active transmitter module 105). At step 1314, the feedback that is generated in response to social media data transmitted/generated from one or more sources is analyzed. A translator can be applied at step 1315 to translate the feedback from another format/context to a desired format/context. In one example, the format refers to local jargon or language.

At step 1316, one or more predominant format of feedback (e.g. language) is defined. At step 1317, the synthesizer module 106 recommend recomposing or retransmitting the social media data according to the format of feedback (e.g. recomposing and translating the social media data to a new language). At step 1318, one or more of the source modules (e.g. receiver module 103, composer module 104 or transmitter module 105) recomposes and transmits the message. Alternately, at step 1319, the synthesizer module recomposes the social media data according to the pre-dominant format (e.g. language, local jargon) that was defined at step 1316. In yet a further embodiment, the recomposed data or data for re-transmission from step 1317 is forwarded to a third party data source (e.g. a different social data communication channel) via an application programming interface for effecting adjustments in subsequently generated and transmitted social data messages within the third party data source channel.

Accordingly, in one example if at step 1316, there are a few dominant languages determined for the feedback, then the synthesizer module 106 recommends to the composer module 104 to recompose the message (to include the local jargon) and the recomposed message is sent from the composer module 104 to the transmitter module 105 for transmission.

### Local or Centralized Recomposition of Messages

In one aspect, if the number of languages detected in the feedback by the synthesizer module 106 (e.g. at step 1316) is greater than a predefined number N, then the synthesizer module 106 requests each transmitter module 105 to translate and recompose the message at each local transmitter module 105 (e.g. local to the geographical destination). Alternately, if the number of languages detected in the feedback by the synthesizer module 106 is less than N then the synthesizer module 106 requests the composer module 104 to re-compose the message according to the detected feedback language. This is a centralized approach for recomposing the message.

### Determining Transmission Destination of New Messages

In one aspect, the synthesizer module 106 defines adjustments for new social media data messages based on prior knowledge, learned patterns and pre-defined rules as shown in FIG. 13A. For example, the determined patterns at step 1308 may reveal one or more influencers for a particular topic. Accordingly, the synthesizer module 106 is configured to define adjustments to the operations of the source modules 103, 104 and 105 to tailor subsequent social media data of the same topic according to formatting preferences (e.g. language), content and/or destination of the revealed influencers.

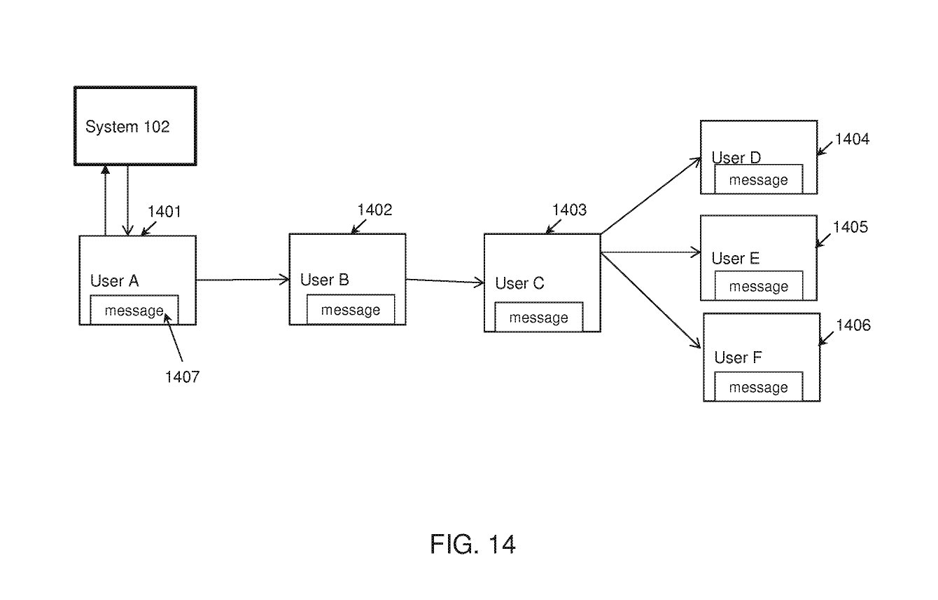

In yet another aspect, the synthesizer module 106 is configured to determine an inflection point as part of the determined patterns (e.g. step 1308). The schematic for determining an inflection point is shown in FIG. 14. That is, a social media data message 1407 is communicated from a user A 1401 to a user B 1402 to a user C 1403. The user C 1403 then broadcasts the message to user D 1404, user E 1405, and user F 1406. The message 1407 destinations can be tracked for example by including markers (e.g. cookies) within the message 1407 to see how the message 1407 that was initially intended for user A and transmitted by the system 102 to user A then gets passed around to other user(s) (e.g. tracking IP addresses of users).

One alternative to cookies for tracking the message and/or message path and/or message visibility is real time engagement metrics (click through metrics that are fed back to the transmitter module and/or synthesizer module) for subsequent analysis. In one aspect, the velocity and frequency of these engagement metrics (real time, near real time) could subsequently be used to alter the telemetry (time of day, frequency, and content) of the delivered content (e.g. by affecting the content composed by the active composer module).

In other aspects, as described herein based on the analysis performed by the synthesizer module on the feedback received (e.g. markers, click through metrics) then adjustment parameters are provided to the modules 103, 104, 105 that can result in altering subsequent content, format of content, language of content, transmission time, transmission schedule of messages, transmission destination, and operation of each of the modules.

Based on the transmission path, the system 102 is then configured to determine that the inflection point or individual is user C 1403 as they subsequently broadcast the message to multiple sources. Accordingly, the synthesizer module 106 detects this pattern (e.g. step 1308 in FIG. 13A) and defines that subsequent social media data messages should be sent to the inflection user C 1403 (e.g. as transmitted by the transmitter module 105). In general, an inflection point or an inflection user in the social data network is a user account that retransmits a message to a certain number of users. The certain number of users is more than the number of users that another user account has reached or more than any other user account has reached.

General example embodiments of the systems and methods are described below.

In general, a method performed by a computing device for communicating social data, includes: obtaining social data; deriving at least two concepts from the social data; determining a relationship between the at least two concepts; composing a new social data object using the relationship; transmitting the new social data object; obtaining user feedback associated with new social data object; and computing an adjustment command using the user feedback, wherein executing the adjustment command adjusts a parameter used in the method.

In an aspect of the method, an active receiver module is configured to at least obtain the social data, derive the least two concepts from the social data, and determine the relationship between the at least two concepts; an active composer module is configured to at least compose the new social data object using the relationship; an active transmitter module is configured to at least transmit the new social data object; and wherein the active receiver module, the active composer module and the active transmitter module are in communication with each other.

In an aspect of the method, each of the active receiver module, the active composer module and the active transmitter module are in communication with a social analytic synthesizer module, and the method further includes the social analytic synthesizer module sending the adjustment command to at least one of the active receiver module, the active composer module and the active transmitter module.

In an aspect of the method, the method further includes executing the adjustment command and repeating the method.

In an aspect of the method, obtaining the social data includes the computing device communicating with multiple social data streams in real time.

In an aspect of the method, determining the relationship includes using a machine learning algorithm or a pattern recognition algorithm, or both.

In an aspect of the method, composing the new social data object includes using natural language generation.

In an aspect of the method, the method further includes determining a social communication channel over which to transmit the new social data object, and transmitting the new social data object over the social communication channel, wherein the social communication channel is determined using at least one of the at least two concepts.

In an aspect of the method, the method further includes determining a time at which to transmit the new social data object, and transmitting the new social data object at the time, wherein the time is determined using at least one of the at least two concepts.

In an aspect of the method, the method further includes adding a data tracker to the new social data object before transmitting the new social data object, wherein the data tracker facilitates collection of the user feedback.

In an aspect of the method, the new social data object is any one of text, a video, a graphic, audio data, or a combination thereof.

In general, there is provided a method performed by a computing device for communicating social data, comprising: obtaining the social data from one or more sources; composing a new social data object derived from the social data; transmitting the new social data object; obtaining at least one feedback associated with the new social data object; computing an adjustment command using said feedback, wherein executing the adjustment command adjusts at least one of steps of obtaining, composing, and transmitting for subsequent social data objects in dependence upon said feedback.

In one aspect, an active receiver module is configured to at least obtain the social data; an active composer module is configured to at least compose the new social data object; an active transmitter module is configured to at least transmit the new social data object; and wherein the active receiver module, the active composer module and the active transmitter module are in communication with a social analytic synthesizer module for computing the adjustment.

In another aspect, each feedback is weighted according to predefined rules and a higher weighting being associated with a higher degree of adjustment.

In another aspect, computing an adjustment further comprises determining patterns based on feedback associated with data from each of the active receiver module, the active composer module and the active transmitter module, the patterns for use in subsequently generating the adjustment to the respective at least one steps of obtaining, composing and transmitting subsequent social data objects.

In another aspect, computing an adjustment for the step of obtaining said at least one feedback further comprises using said patterns for deriving at least two concepts from the social data; determining a relationship between the at least two concepts; and composing the new social data object using the relationship.

In another aspect, the social data comprises a social data object and the new social data object comprises the social data object.

In another aspect, the method further comprises the social analytic synthesizer module sending the adjustment command to at least one of the active receiver module, the active composer module and the active transmitter module.

In another aspect, the method further comprises executing the adjustment command and repeating the method.

In another aspect, obtaining the social data comprises the computing device communicating with multiple social data streams in real time.

In another aspect, determining patterns comprises using at least one of: a machine learning algorithm and a pattern recognition algorithm based on prior positive feedback associated with the social data.

In another aspect, the adjustment based on said patterns further adjusts the social communication channel over which to transmit the new social data object, and the method comprises transmitting the new social data object over the social communication channel.

In another aspect, determining a time at which to transmit the new social data object, and transmitting the new social data object at the time, wherein the time is determined using detected patterns from said feedback.

In another aspect, wherein the social communication channel is determined based upon determining an inflection point of prior communication of the new social data based upon said feedback, the inflection point indicating a user that multiply broadcasts the new social data, the adjustment comprising causing subsequent transmission of social data to be transmitter to the inflection point.

In another aspect, the method further comprises transmitting the new social data object to at least one destination, wherein said at least one feedback indicates a transmission path of said new social data, the transmission path indicating re-transmission of said new social data to an alternate destination than said at least one destination and computing said adjustment comprises adjusting subsequent destination of subsequent social data objects in dependence upon said alternate destination.

In another aspect, the adjustment further comprises re-composing subsequent social data objects in dependence upon said alternate destination.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing device for communicating social data, comprising:
obtaining the social data from one or more sources;
composing a new social data object derived from the social data;
transmitting the new social data object;
obtaining at least one feedback associated with the new social data object, said at least one feedback generated in response to at least one of obtaining, composing and transmitting the new social data object in association with the social data and the new social data object;
analyzing said at least one feedback to compute an adjustment command using said feedback, wherein executing the adjustment command adjusts at least one of steps of obtaining, composing, and transmitting for subsequent social data objects in dependence upon said feedback.

2. The method of claim 1, wherein an active receiver module is configured to at least obtain the social data; an active composer module is configured to at least compose the new social data object; an active transmitter module is configured to at least transmit the new social data object; and wherein the active receiver module, the active composer module and the active transmitter module are in communication with a social analytic synthesizer module for computing the adjustment.

3. The method of claim 1, wherein each feedback is weighted according to predefined rules and a higher weighting being associated with a higher degree of adjustment.

4. The method of claim 2, wherein computing an adjustment further comprises analyzing said at least one feedback for determining patterns based on feedback associated with data from each of the active receiver module, the active composer module and the active transmitter module, the patterns for use in subsequently generating the adjustment to the respective at least one steps of obtaining, composing and transmitting subsequent social data objects.

5. The method of claim 4 wherein computing an adjustment for the step of obtaining said at least one feedback further comprises using said patterns for deriving at least two concepts from the social data; determining a relationship between the at least two concepts; and composing the new social data object using the relationship.

6. The method of claim 1 wherein the social data comprises a social data object and the new social data object comprises the social data object.

7. The method of claim 2, wherein the method further comprises the social analytic synthesizer module sending the adjustment command to at least one of the active receiver module, the active composer module and the active transmitter module.

8. The method of claim 1 further comprising executing the adjustment command and repeating the method.

9. The method of claim 1 wherein obtaining the social data comprises the computing device communicating with multiple social data streams in real time.

10. The method of claim 4 wherein determining patterns comprises using at least one of: a machine learning algorithm and a pattern recognition algorithm based on prior positive feedback associated with the social data.

11. The method of claim 4, wherein the adjustment based on said patterns further adjusts the social communication channel over which to transmit the new social data object, and the method comprises transmitting the new social data object over the social communication channel.

12. The method of claim 11 further comprising determining a time at which to transmit the new social data object, and transmitting the new social data object at the time, wherein the time is determined using detected patterns from said feedback.

13. The method of claim 11, wherein the social communication channel is determined based upon determining an inflection point of prior communication of the new social data based upon said feedback, the inflection point indicating a user that multiply broadcasts the new social data, the adjustment comprising causing subsequent transmission of social data to be transmitter to the inflection point.

14. The method of claim 1 wherein the new social data object is any one of text, a video, a graphic, a picture, audio data, or a combination thereof.

15. The method of claim 1, further comprising transmitting the new social data object to at least one destination, wherein said at least one feedback indicates a transmission path of said new social data, the transmission path indicating re-transmission of said new social data to an alternate destination than said at least one destination and computing said adjustment comprises adjusting subsequent destination of subsequent social data objects in dependence upon said alternate destination.

16. The method of claim 15, wherein the adjustment further comprises re-composing subsequent social data objects in dependence upon said alternate destination.

17. A server system configured to communicate social data, comprising:
a processor;
a communication device;
a memory device; and
wherein the memory device comprises computer executable instructions for performing method step 1.

18. The method of claim 1, wherein composing the new social data object further comprises automatically translating from a first language format to a second language format according to said feedback.

19. The method of claim 14, wherein each of the text, audio and video object further comprises a compilation of respective text, audio and video objects components merged together or a combination thereof.

20. The method of claim 1, wherein said at least one source comprises at least one of: an active receiver module associated with a first social data channel and third party data sources associated with at least one other social data channel.

21. A system configured to communicate social data comprising:
an active receiver module configured to obtain social data from at least one source;
an active composer module configured to compose new social data based upon the obtained social data;
an active transmitter module configured to transmit the new social data according to at least one transmission parameter;
a synthesizer module configured to communicate with each of the active receiver module, the active composer module and the active transmitter module for receiving feedback on previously composed and transmitted social data, the feedback indicating parameters associated with whether prior social data messages were viewed;
the synthesizer module further configured for computing an adjustment to at least one of the active receiver module, the active transmitter module, and the active composer module in dependence upon the feedback .

22. The system of claim 21, wherein the adjustment further comprises adjusting telemetry parameters comprising: time of day, frequency, and content of new social data messages for subsequent transmission via the active transmitter module.

23. The system of claim 21, wherein the feedback comprises at least one of: number of clicks, number of forwards, time trackers for determining length of time the composed social data is viewed; and destination trackers for comparing expected destination of social data message to actual destinations.

24. The system of claim 21 wherein the synthesizer module further comprises at least one of audio, picture, video and text processing module for recognizing and extracting metadata pre-defined according to the feedback received at the synthesizer module.

25. The system of claim 21, wherein the feedback is generated in connection to at least one user performing at least one of the following operations in association with said new social data object: opening, viewing, re-posting to at least one social communication channel, re-transmitting to at least one other user, converting to a new language, and modifying content of the message.
